(19) United States
(12) Patent Application Publication
(10) Pub. No.: US 2005/0045740 A1
(43) Pub. Date: Mar. 3, 2005

(54) Vehicular washer nozzle

(75) Inventors: Hirofumi Takemoto, Saitama (JP); Eiji Ishizuka, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 10/932,484

(22) Filed: Sep. 2, 2004

(30) Foreign Application Priority Data
Sep. 2, 2003 (JP) 2003-309924
Nov. 11, 2003 (JP) 2003-380598

(51) Int. Cl. B05B 1/10; B60S 1/46

(52) U.S. Cl. 239/284.1; 239/284.2

(57) ABSTRACT

A washer nozzle has nozzle outlets 7, 8 which are provided within fluid injecting openings in a nozzle main body for ejecting a washer fluid. The nozzle main body has extended portions which are provided at transverse end portions of the nozzle main body which are situated transversely outwardly of the fluid ejecting openings in such a manner as to extend transversely. The extended portions prevent an air flow from coming around the end portions of the nozzle main body to reach the fluid ejecting openings.

The present invention claims foreign priority to Japanese patent application no. JP-2003-309924 filed on Sep. 2, 2004 and JP-2003-380598 filed on Nov. 11, 2003, the contents of which are incorporated herein by reference.

### BACKGROUND OF THE PRESENT INVENTION

1. Field of the Present Invention

The present invention relates to a vehicular washer nozzle for injecting a washer fluid onto a windscreen of a vehicle.

2. Description of the Related Art

Conventionally, a windscreen washer system is installed in a vehicle for injecting a washer fluid for cleaning a windscreen of the vehicle when the visibility of the driver cannot be secured only by wiping the windscreen {for example, Japanese Patent Unexamined Publication JP-A-10-236283 (paragraphs 0010 to 0011, FIG. 2A)}. A representative form of a washer nozzle includes spray and jet types.

The spray-type washer nozzle is such as to inject a washer fluid toward the windscreen in the form of mist and hence is easily affected by an air flow caused when the vehicle is running at high speeds, causing a problem that the injected washer fluid tends to gather at a central portion of a washer fluid reaching area on the windscreen. Due to this problem, it is a normal practice to provide a spray-type washer nozzle on an engine hood or cowl top at a position facing driver and front passenger' seats, respectively. The washer nozzles so provided are caused to inject the washer fluid simultaneously so that the washer fluid so injected can cover the whole of the windscreen.

However, with the spray-type washer nozzle, since two washer nozzles are required, the parts cost must allow for the provision of two washer nozzles, causing a problem that the costs are increased.

In contrast, the jet-type washer nozzle is such as to inject a washer fluid toward the windscreen in the form of a flow of fluid and hence is difficult to be affected by an air flow caused when the vehicle is running at high speeds. Due to such the structure, on vehicles such as keicars or lightweight passenger vehicles which are narrow in width, a single jet-type washer nozzle is disposed on the engine hood or cowl top at a central position between the driver and front passenger seats in such a manner as to inject the washer fluid toward three directions so that the washer fluid so injected can cover the whole of the windscreen.

With the jet-type washer nozzle, however, since the washing efficiency is lower than that of the spray-type washer nozzle, the washer fluid is required substantially by 30% more than that is required by the spray-type washer nozzle when attempting to have the same washing efficiency as that of the spray-type washer nozzle. Due to this, since a large amount of washer fluid is used on vehicles using the jet-type washer nozzle, the capacity of a washer fluid tank needs to increased, causing a problem that the vehicle weight is increased overall (0.5 kg for the keicar category).

FIG. 14 shows a conventional washer nozzle; FIG. 14A showing a plan view of a nozzle main body, FIG. 14B a left side view of the nozzle main body, FIG. 14C a back-side view of the nozzle main body.

When used herein, “front” denotes a traveling direction of the vehicle, “rear” denotes a reversing direction of thereof, “upwardly” denotes a vertically upward direction of the vehicle, “downwardly” denotes a downward direction thereof, and “left and right” denotes a transverse direction of the vehicle.

As shown in FIGS. 14A, 14B, 14C, a nozzle main body 110 of a conventional washer nozzle 100 is placed on an engine hood 200 or the like which is disposed in front of a windscreen 300 (refer to FIG. 15). Then, nozzles 120, 130 for injecting a washer fluid W (refer to FIG. 15) toward a washer fluid reaching area F (refer to FIG. 15) on the windscreen (300) are disposed on a side of the nozzle main body 110 which faces the windscreen (300) at transversely symmetrical positions.

As shown in FIG. 14A, the nozzle main body (110) is formed into a substantially quadrangular shape as viewed from the top. The shape of sides 111, 112 of the nozzle main body 110 is formed into a shape which extends in the traveling direction of the vehicle. A front side thereof is formed substantially into a flat shape. Aback side thereof is constituted by back sides 114, 115 which are inclined transversely in such a manner as to follow directions (directions indicated by arrows A, B) in which the respective nozzles 120, 130 inject the washer fluid (W).

As shown in FIG. 14B, when viewed from the side, the nozzle body 110 is formed substantially into a triangular shape which moderately declines toward a front end thereof. Thus, a top side 116 of the nozzle main body 110 is declined moderately toward the front thereof so as to follow an injecting direction (a direction denoted by an arrow C which is directed toward the washer fluid reaching area of the windscreen) of the washer fluid (W), whereby the resistance of air flow caused while the vehicle is running is reduced so as to attempt to generate no wind noise.

As shown in FIG. 14C, openings 117, 118 are formed in the back sides 114, 115 of the nozzle main body 110 in order to expose the nozzles 120, 130. The openings 117, 118 are made to face the rear obliquely so as to match washer fluid injecting directions (directions indicated by arrows A, B in FIG. 14A) of the nozzles 120, 130. Due to this, left and right end portions of the openings 117, 118 are formed nearer to the left and right sides of the nozzle main body, respectively. Then, the sides 111, 112 of the nozzle main body 110 extend straight forward from the left and right end portions, respectively, as shown in FIG. 14A.

The washer fluid (W) which has reached the windscreen (300) is wiped by a wiper blade (not shown). Then, the wiper blade (not shown) moves back and forth in a wiping area, whereby the windscreen (300) is cleaned with the washer fluid (W).

The nozzle main body 110 according to the related art is formed into the shape which is illustrated in FIGS. 14A, 14B, 14C and Japanese Patent Unexamined Publication JP-A-10-236283. Then, the washer nozzle 100 is constructed so as to provide a density distribution of the washer fluid (W) which reaches the windscreen (300) at the washer fluid reaching area (F), as shown in FIG. 15. The washer fluid (W) which is sprayed from the washer nozzle 100 in the form of mist is allowed to reach a wide area, and a certain cleaning effect can be expected. However, there is caused a problem that the washer fluid (W) so injected is scattered by the flow of air applied thereto while the vehicle is running at high speeds to thereby reduce the washer fluid reaching area, causing the cleaning effect to be reduced.

FIG. 15 shows a drawing illustrating a state of a washer fluid which is injected from the washer nozzles to the windscreen, as well as a state of the windscreen as viewed from the interior of a passenger compartment. Note that the state of the washer fluid shown in FIG. 15 is a state resulting when the pressure of an air flow is applied to the washer fluid so injected while the vehicle is running at 100 km/h.

As shown in FIG. 15, the washer fluid (W) injected from the washer nozzle (100) is injected to a high position on the windscreen 300 also when the vehicle is running at high speeds. As shown in FIG. 14A, however, while the vehicle is running at high speeds, there is caused an air flow flowing along the left and right sides 111, 112 of the nozzle main body 110 as indicated by arrows D, E. The air flow flows around the corners of the nozzle main body 110 to the back sides 114, 115 thereof where the openings 117, 118 are formed. Then, the washer fluid W injected from the nozzles 120, 130 is disturbed when it is subjected to the pressure of the air flow that has reached the back sides 114, 115 and is prevented from expanding in the transverse direction of the vehicle, as shown in FIG. 15. Accordingly, it narrows the washer fluid reaching area F, causing a problem that the washer fluid W is not allowed to reach the wide range of the windscreen.

Thus, since the washer fluid reaching area F gets narrow in the transverse direction, the washer application area F is modified to be centered at the central portion of the windscreen 300. Due to this, the washer fluid W is not cause to spread over the wide range of the windscreen 300, causing a problem that the washer fluid cannot clean the windscreen by the wiper blade efficiently, whereby the cleaning efficiency cannot be enhanced.

### SUMMARY OF THE PRESENT INVENTION

It is desired that, even if only the single washer nozzle is provided on each vehicle, the washer fluid is allowed to cover the whole area of the windscreen so that the washer fluid spread and is wiped by the wiper blade with good efficiency.

With a view to solving the problems, an object of the present invention is to provide a vehicular washer nozzle which can provide a good cleaning efficiency when a washer fluid is applied to the windscreen while the vehicle is also running at high speeds.

With a view to attaining the object, according to a first aspect of the present invention, there is provided a vehicular washer nozzle for injecting a washer fluid, comprising:
a nozzle main body provided with an opening through which washer fluid is injected, the nozzle main body including;
   an extended portion provided on an end portion located transversely outward of the opening; and
at least one of a nozzle for injecting the washer fluid,
   wherein the extended portion extends to a transversely outward direction for preventing an air flow from coming around the end portion transversely inwardly.

According to the first aspect of the present invention, since the vehicular washer nozzle is provided with the extended portion which is disposed at the transverse end portion of the nozzle main body which is situated transversely outwardly of the washer fluid injection opening in the nozzle main body in such a manner as to extend transversely, the extended portion so provided can prevent the air flow applied to the nozzle main body from coming around the end portion of the nozzle main body to reach the opening to thereby effect the washer fluid that has just been injected. Thus, with the vehicular washer nozzle, since the washer fluid that is to be injected can be injected to the wider area on the windscreen even while the vehicle is running at high speeds, a desired injecting condition can be obtained, which results in an ideal washer fluid reaching area. Consequently, the vehicular washer nozzle can enhance the cleaning efficiency of the windscreen by the wiper blade.

According to a second embodiment of the present invention according to the first aspect of the present invention, a transverse length of the extended portion is equal to or longer than a transverse length of the opening.

According to the second embodiment, since the vehicular washer nozzle is set such that the extended portion is provided to extend the length which is equal to or longer than the transverse length of the opening, the air flow can be prevented from coming around the end portion of the nozzle main body to reach the opening while the vehicle is running. Thereby the vehicular washer nozzle can maintain the desired injecting condition in an ensured fashion even while the vehicle is running at high speeds.

According to a third aspect of the present invention according to the first aspect of the present invention, a transverse length of the extended portion is equal to or longer than a half of a transverse length of the opening, and is shorter than a transverse length of the opening.

According to the third aspect of the present invention, since the vehicular washer nozzle is set such that the extended portion is provided to extend the length which is equal to or longer than a half of the transverse length of the opening and also is shorter than the transverse length of the opening. The length of the extended portion can be made to be such that the design of the washer nozzle is affected as little as possible. Accordingly, the extended portion can be set so as to obtain a sufficient air regulating effect.

According to a fourth aspect of the present invention according to the first aspect of the present invention, the end portion is formed so as to extend transversely outwardly as the end portion extends toward an opposite direction to a traveling direction of a vehicle.

According to the fourth aspect of the present invention, since the vehicular washer nozzle is formed such that the end portion of the nozzle main body is formed in such a manner as to extend transversely outwardly as the end portion extends toward the opposite direction to the traveling direction of the vehicle, the air flow is allowed to flow transversely outwardly of the nozzle main body. Due to this, it can be ensured further that the washer fluid injected from the interior of the opening can be affected by the air flow.

In addition, with the vehicular washer nozzle, since the length of the extended portion can be made as short as possible. Therefore a limitation on the design of the vehicular washer nozzle by the extended portion can be made as little as possible.

According to a fifth aspect of the present invention according to the first aspect of the present invention, the washer nozzle further comprising:
a base seat,
wherein the nozzle main body is provided on the base seat, and
a surface of the base seat is formed continuously from a surface of the nozzle main body.

According to the fifth aspect of the present invention, since the vehicular washer nozzle is constructed such that the nozzle main body is placed on the base seat, whose surface is formed in such a manner as to continue from the surface of the nozzle main body, the air regulating effect of the air flow around a lower side of the nozzle main body can be enhanced, and the effect of air flow on the injected washer fluid can be made much smaller.

According to a sixth aspect of the present invention according to the first aspect of the present invention, the nozzle main body is of a spray type.

According to the sixth aspect of the present invention, since the vehicular washer nozzle is such that the nozzle main body is of the spray type, there can be provided both the advantages of the conventional spray-type and jet-type washer nozzles. Due to this, even if the spray-type washer nozzle, which is easy to be affected by an air flow, is used, the vehicular washer nozzle can be used in the preferred fashion as has been described above, and the number of washer nozzles can be reduced by one when compared with the conventional example, and hence the costs can be reduced.

According to a seventh aspect of the present invention according to the first aspect of the present invention, the opening is provided so as to be inclined transversely outwardly at an angle of about 25° with respect to a rear direction of a vehicle as viewed from a top of the nozzle main body.

According to an eighth aspect of the present invention according to the seventh aspect of the present invention, the nozzle is formed so as to be inclined in the same direction as that of the opening.

According to a ninth aspect of the present invention according to the first aspect of the present invention, the opening is formed so as to be inclined upwardly at an angle of about 12° with respect to a rear direction of a vehicle as viewed from a side of the nozzle main body.

According to a tenth aspect of the present invention according to the ninth aspect of the present invention, the nozzle is formed so as to incline in the same direction as that of the opening.

According to an eleventh aspect of the present invention according to the first aspect of the present invention, the vehicular washer nozzle has first and second nozzles,
the first nozzle is disposed in such a manner that a center axis of an injecting direction is inclined transversely outwardly at an angle of about 16° as viewed from a top of the nozzle main body, and
the second nozzle is disposed in such a manner that a center axis of an injecting direction which is different from the injection direction of the first nozzle is inclined transversely outwardly at an angle of about 23° as viewed from a top of the nozzle main body.

According to a twelfth aspect of the present invention according to the first aspect of the present invention, the nozzle is disposed in such a manner that a center axis of an injecting direction is inclined upwardly at an angle of about 20° as viewed from a side of the nozzle main body.

According to a thirteenth aspect of the present invention according to the first aspect of the present invention, an angle defined between side surfaces of the nozzle main body is about 33°.

According to a fourteenth aspect of the present invention according to the first aspect of the present invention, a front surface of the nozzle main body is formed substantially into a flat shape as viewed from a top of the nozzle main body

According to a fifteenth aspect of the present invention according to the first aspect of the present invention, a rear surface of the nozzle main body is formed substantially into an arc-like shape as viewed from a top of the nozzle main body.

According to a sixteenth aspect of the present invention according to the first aspect of the present invention, a top surface of the nozzle main body is formed substantially into a triangular shape and descend toward a front direction as viewed from a side of the nozzle main body.

According to a seventeenth aspect of the present invention according to the first aspect of the present invention, an edge defined between a side surface and a rear surface is round shape.

According to an eighteenth aspect of the present invention according to the fifth aspect of the present invention, the base seat is formed integrally with the nozzle main body.

According to a twentieth aspect of the present invention, there is provided a vehicular washer nozzle for injecting a washer fluid, comprising:
a nozzle main body provided with an opening through which washer fluid is injected, the nozzle main body including;
   an end portion located on a transversely outward end of the opening;
an extended portion extended from the end portion of the nozzle main body to a transversely outward direction; and
at least one of a nozzle for injecting the washer fluid,
wherein the extended portion prevents an air flow from coming around the end portion transversely inwardly.

### BRIEF DESCRIPTION OF THE DRAWINGS

FIG. 1 is a drawing showing a vehicular washer nozzle according to a first embodiment of the present invention, which is a plan view of a vehicle showing a state in which a nozzle main body is set;

FIG. 2 is a drawing showing the vehicular washer nozzle according to the first embodiment of the present invention, which is an enlarged plan view of a nozzle main body;

FIG. 3 is a drawing showing the vehicular washer nozzle according to the first embodiment of the present invention, which is an enlarged back view of the nozzle main body;

FIG. 4 is a drawing showing the vehicular washer nozzle according to the first embodiment of the present invention, which is an enlarged partially cross-sectional side view of the nozzle main body;

FIG. 5 is a drawing showing the operation of the vehicular washer nozzle according to the first embodiment of the present invention, which illustrates a state of the washer fluid that is injected from the washer nozzle to a windscreen while the vehicle is running at 100 km/h;

FIG. 6 is a drawing showing a vehicular washer nozzle according to a second embodiment of the present invention, which is an end view showing a state in which a nozzle main body is set in place;

FIG. 7 is a drawing showing the vehicular washer nozzle according to the second embodiment of the present invention, which is an enlarged perspective view of the nozzle main body as seen from the interior of a passenger compartment;

FIG. 8 is a drawing showing a vehicular washer nozzle according to a first example of the present invention, which is a back view of a nozzle main body having extended portions which are formed on a conventional nozzle main body using clay;

FIG. 9 is an explanatory drawing illustrating a state in which a washer fluid reaches the windscreen of a vehicle while the vehicle on which the nozzle main body shown in FIG. 8 is mounted is running at 100 km/h after the washer fluid has been injected from the nozzle main body so mounted;

FIG. 10 is a drawing showing a vehicular washer nozzle according to a second example of the present invention, which is a back view of a nozzle main body having extended portions which are formed on a conventional nozzle main body using clay;

FIG. 11 is an explanatory drawing illustrating a state in which a washer fluid reaches the windscreen while the vehicle on which the nozzle main body shown in FIG. 10 is mounted is running at 100 km/h after the washer fluid has been injected from the nozzle main body so mounted;

FIG. 12 is a drawing showing a vehicular washer nozzle according to a third example of the present invention, which is a back view of a nozzle main body having extended portions which are formed on a conventional nozzle main body using a clay;

FIG. 13 is an explanatory drawing illustrating a state in which a washer fluid reaches the windscreen of a vehicle while the vehicle on which the nozzle main body shown in FIG. 12 is mounted is running at 100 km/h after the washer fluid has been injected from the nozzle main body so mounted;

FIG. 14A is a plan view of a nozzle main body of the conventional washer nozzle;

FIG. 14B is a left side view of the nozzle main body of the conventional washer nozzle;

FIG. 14C is a back view of the nozzle main body of the conventional washer nozzle; and

FIG. 15 is a drawing showing a state in which a washer fluid is injected to a windscreen of a vehicle from the conventional washer nozzle while the vehicle is running, which illustrates a state of the windscreen as seen from the interior of the passenger compartment.

### DETAILED DESCRIPTION OF THE PREFERRED EMBODIMENTS

[First Mode for Carrying out the Present Invention]

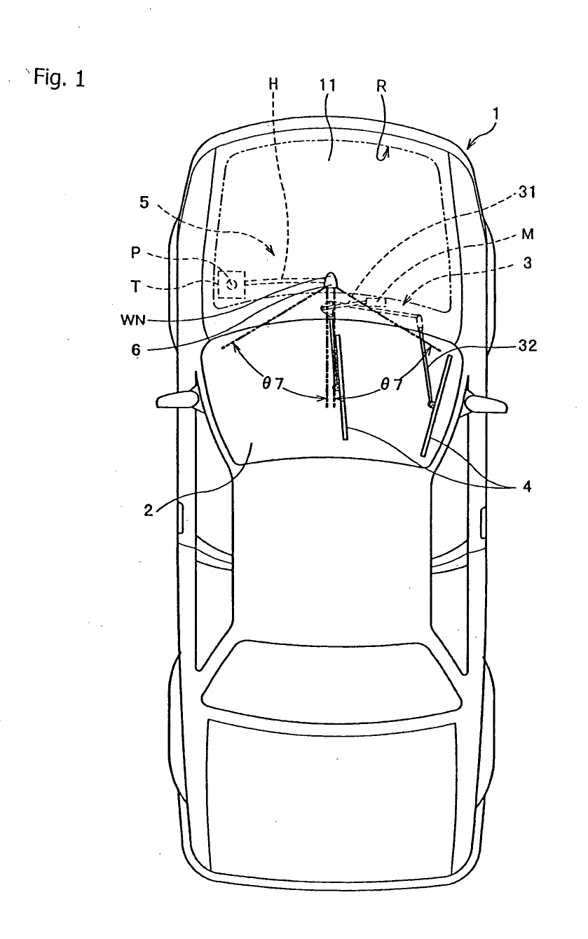

Hereinafter, referring to FIGS. 1 to 5, a vehicular washer nozzle according to a first embodiment of the present invention will be described.

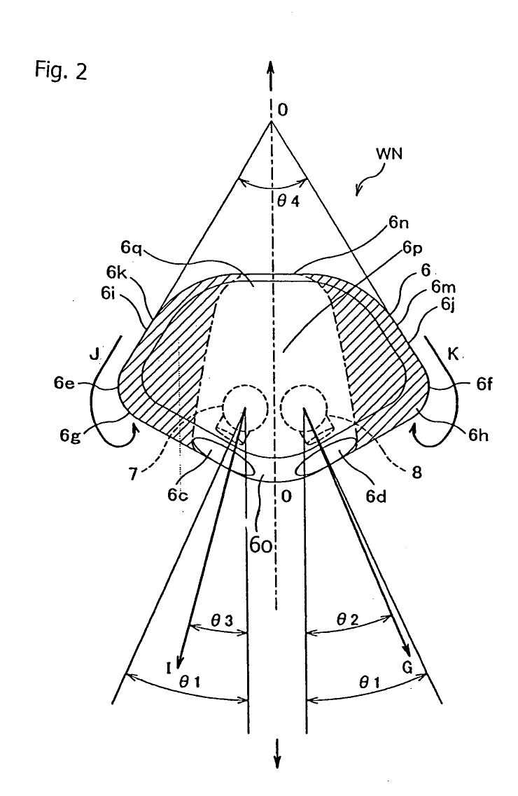

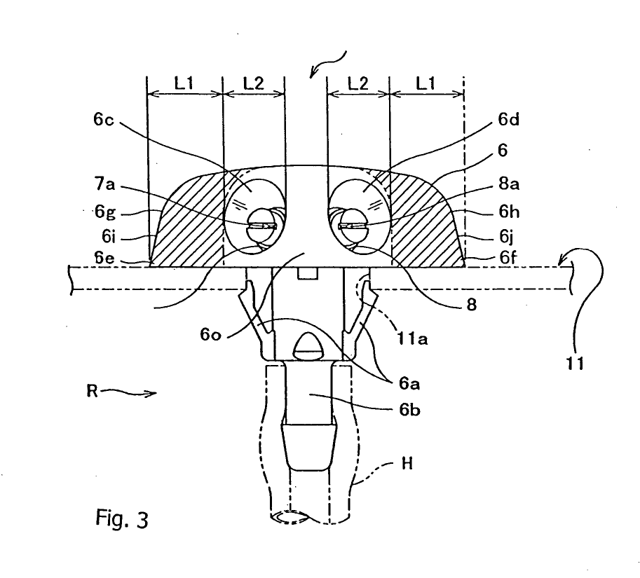

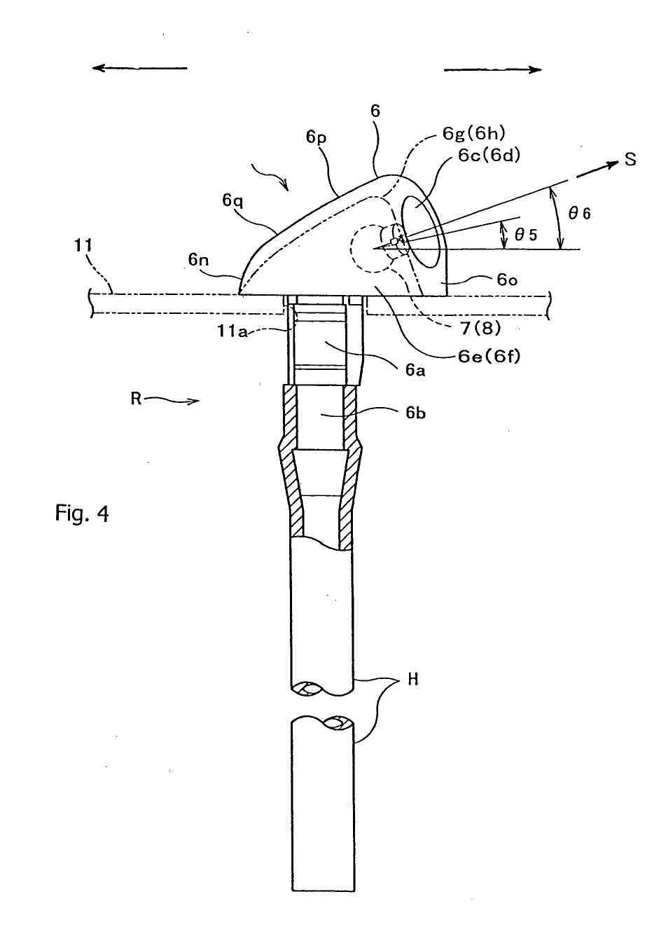

FIG. 1 is a drawing showing a vehicular washer nozzle according to the first embodiment of the present invention, which is a plan view of a vehicle showing a state in which a nozzle main body is set. FIG. 2 is a drawing showing the vehicular washer nozzle according to the first embodiment of the present invention, which is an enlarged plan view of a nozzle main body. FIG. 3 is a drawing showing the vehicular washer nozzle according to the first embodiment of the present invention, which is an enlarged back view of the nozzle main body. FIG. 4 is a drawing showing the vehicular washer nozzle according to the first embodiment of the present invention, which is an enlarged partially cross-sectional side view of the nozzle main body.

As shown in FIG. 1, a vehicle 1 has provided thereon a washer system 5 for applying a washer fluid W to a windscreen 2 when the windscreen 2 gets dirty, and a wiper system 3 for operating wiper blades 4 in response to the injection of washer fluid W from nozzles 7, 8 (refer to FIGS. 2 and 3) so as to wipe the windscreen to which the washer fluid W is applied to clean the same.

The wiper system 3 includes a wiper motor M which constitutes a power source thereof, a link rod 31 adapted to be activated by a gear link mechanism (not shown) placed on the wiper motor M, wiper arms 32 connected to the link rod 31 so as to swing and wiper blades 4 which are disposed at distal ends of the wiper arms 32 for wiping the windscreen 2. The wiper motor M and the link rod 31 are placed on a cowl top 9 (refer to FIG. 6) which is concealed by an engine hood 11 or the like. The wiper system 3 is constructed such that, when a wiper switch (not shown) disposed at a position in the vicinity of a driver's seat is switched on, the wiper motor M starts to rotate to cause the wiper blades 4 to continuously perform a wiping operation. Note that when a mist switch (not shown) is switched on, the wiper motor M rotates to perform a wiping operation only once.

The washer system 5 includes a washer fluid tank T, a washer motor pump P which constitutes a driving source for injecting a washer fluid W in the washer fluid tank T to the windscreen 2, a hose H for sending the washer fluid W in the washer fluid tank T to a washer nozzle WN and the washer nozzle WN having nozzles 7, 8 for injecting the washer fluid W to the windscreen 2. The washer system 5 is constructed such that, when a washer switch (not shown) disposed at a position in the vicinity of the driver's seat is switched on, the washer pump P is activated. Accordingly, the washer fluid W is injected from the nozzles 7, 8.

The washer fluid tank T is made up of a resin tank and is fixed to an internal sidewall of an engine compartment R.

The washer pump P is an electric pump apparatus disposed on a bottom surface of the washer fluid tank T. A pump (not shown) for injecting the washer fluid W and a motor (not shown) for rotating an impeller (not shown) of the pump are provided integrally in the washer pump P.

The hose H is made up of, for example, a thin resin tube and is connected to the washer motor pump P at one end and to the washer nozzle WN at the other end thereof.

The washer nozzle WN is disposed, for example, as shown in FIG. 1, at a position that is situated substantially on a center line of the surface of the engine hood 11 and close to the windscreen 2 and has a single nozzle main body 6.

As shown in FIGS. 3 and 4, the nozzle main body 6 has at a lower part thereof an elastic locking piece 6a which attaches to the nozzle main body 6 within a placing hole 11a in the engine hood in a one-touch fixing fashion so as to fix the nozzle main body 6 in place therein and a pipe portion 6b to which the hose H is connected. Note that the elastic locking piece 6a and the pipe portion H are formed integrally.

As shown in FIGS. 2 and 3, the nozzle 7, which is of a spray type, and the nozzle 8, which is also of a spray type, are installed in the nozzle main body 6 for injecting the washer fluid W to a part of the washer fluid reaching area on the wind screen 2 and the other part of the washer fluid reaching area, respectively. The two nozzles 7, 8 are placed in openings 6c, 6d formed in the nozzle main body 6 so as to be exposed therefrom.

As shown in FIG. 2, the openings 6c, 6d are formed so as to incline to the left and right, respectively, at an angle of about 25° with respect to the rear of the vehicle as viewed from the top of the nozzle main body 6. The nozzles 7, 8, which are installed in the openings 6c, 6d, respectively, are also disposed so as to incline in the same directions as those of the openings 6c, 6d.

As shown in FIG. 4, the openings 6c, 6d are formed so as to incline upwardly at an angle of about 12° with respect to the rear direction as viewed from the side of the nozzle main body 6. The nozzles 7, 8, which are installed in the openings 6c, 6d, respectively, are also disposed so as to incline in the same directions as those of the openings 6c, 6d.

As shown in FIG. 2, the nozzle 7, which injects the washer fluid W toward the front-passenger's seat side of the windscreen 2, is disposed such that the center of an injecting direction (a direction indicated by an arrow 1) in which the washer fluid W is injected from an injection port 7a (refer to FIG. 3) inclines to the left at an angle of about 16° (θ3) as viewed from the top.

The nozzle 8, which injects the washer fluid W toward the driver's seat side of the windscreen 2, is disposed such that the center of an injecting direction (a direction indicated by an arrow G) in which the washer fluid W is injected from an injection port 8a (refer to FIG. 3) inclines to the right at an angle of about 23° (θ2) as viewed from the top.

As shown in FIG. 4, the nozzles 7, 8 are disposed such that the center of an injecting direction (a direction indicated by an arrow S) in which the washer fluid W is injected from the injection ports 7a, 8a (refer to FIG. 3) inclines upwardly at an angle of about 20° (θ6) as viewed from the side.

As shown in FIG. 2, extended portions 6g, 6h (shaded portions in FIGS. 2, 3 and 4) are provided on transverse end portions 6e, 6f of the nozzle main body 6 which are situated transversely outwardly of the openings 6c, 6d, respectively, so as to extend in the transverse direction. Thereby the nozzle main body 6 is formed substantially into a trapezoidal shape which is wide in the transverse direction. The end portions 6e, 6f of the nozzle main body 6 are formed so as to expand transversely outwardly as the end portions extend in an opposite direction to a traveling (forward) direction of the vehicle 1.

The extended portions 6g, 6h are formed on the end portions 6e, 6f which are adapted to prevent an air flow produced while the vehicle is running at high speeds from coming around the end portions of the nozzle main body transversely inwardly.

As shown in FIG. 3, assuming that L1 is a length of the extended portions 6g, 6h in the transverse direction thereof and L2 is a length of the openings 6c, 6d in the transverse direction thereof, the extended portions 6g, 6h are set to satisfy L1≧L2. Namely, the extended portions 6g, 6h are provided so as to extend a length which is equal to or longer than the transverse length of the openings 6c, 6d.

As shown in FIG. 2, sides 6i, 6j of the nozzle main body 6 are each formed so as to have an inclined surface 6k, 6m which inclines to the rear so as to prevent an air flow which flows along the sides 6i, 6j from flowing into the openings 6c, 6d. An angle θ4 defined between the inclined surface 6k and the inclined surface 6m is about 33°.

A front side 6n is formed substantially into a flat shape as viewed from the top and a rear side 6o is formed substantially into an arc-like shape as viewed from the top.

As shown in FIG. 4, a topside 6p of the nozzle main body 6 is formed so as to constitute an inclined side 6q of a substantially triangular shape which descends toward a front end thereof as viewed from the side.

Next, referring to FIG. 2, the function of the vehicular washer nozzle according to the first embodiment of the present invention will be described below.

When the vehicle runs at high speeds, there is produced an air flow flowing along the shape of the surface of the engine hood 11 (refer to FIG. 1).

As shown in FIG. 2, the air flow so produced collides against the nozzle main body 6 and then flows along the inclined surfaces 6k, 6m of the left and right sides 6i, 6j while being restricted to a direction directed obliquely outwardly of arrows J, K. The air flow flowing in the directions indicated by the arrows J, K flows around the end portions 6e, 6f transversely inwardly to reach the back side 6o of the nozzle main body 6 in a spiral fashion. The air flow which flows transversely inwardly to reach the back side 6o of the nozzle main body 6 are scattered in such a manner as to expand in the transverse direction due to the provision the inclined surfaces 6k, 6m on the sides 6i, 6j of the nozzle main body 6. However, since the extended portions 6g, 6h are formed on sides of the end portions 6e, 6f which face the center line O-O so that the distance L1 (refer to FIG. 3) from the end portions 6e, 6f to the openings 6c, 6d, respectively, is made longer, the air flow that has flowed transversely inwardly to reach the back side 6o of the nozzle main body 6 are caused to spin to make a U turn to the end portions 6e, 6f sides. Due to this, the amount of air which is allowed to flow transversely inwardly as far as in front of openings 6c, 6d becomes extremely limited.

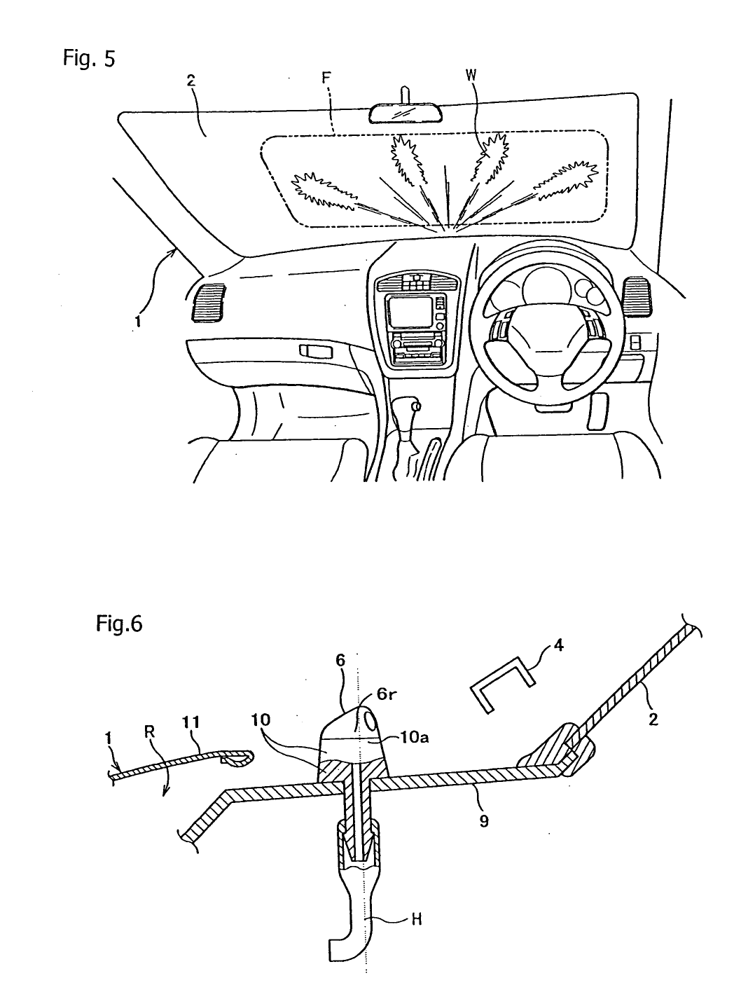

FIG. 5 is a drawing showing the function of the vehicular washer nozzle according to the first embodiment of the present invention, which illustrates a state of the washer fluid that is injected from the washer nozzle to the windscreen while the vehicle is running at 100 km/h.

As shown in FIG. 5, the washer fluid W injected from the nozzles 7, 8 (refer to FIG. 3) to the windscreen 2 reaches substantially the same position on the wind screen 2 as that resulting when the vehicle is stationary without being affected by the air flow. Accordingly, even when the vehicle is running at high speeds, the washer fluid W injected from the nozzles 7, 8 to the windscreen can be expanded to reach the washer fluid reaching area on the wind screen 2 in a state which is close to the ideal washer fluid reaching area F. The washer fluid W that has been allowed to reach the washer fluid reaching area on the windscreen can enhance the cleaning effect resulting from the wiping operation of the wiper blades 4 when it is allowed to expand over the wide range.

[Second Embodiment]

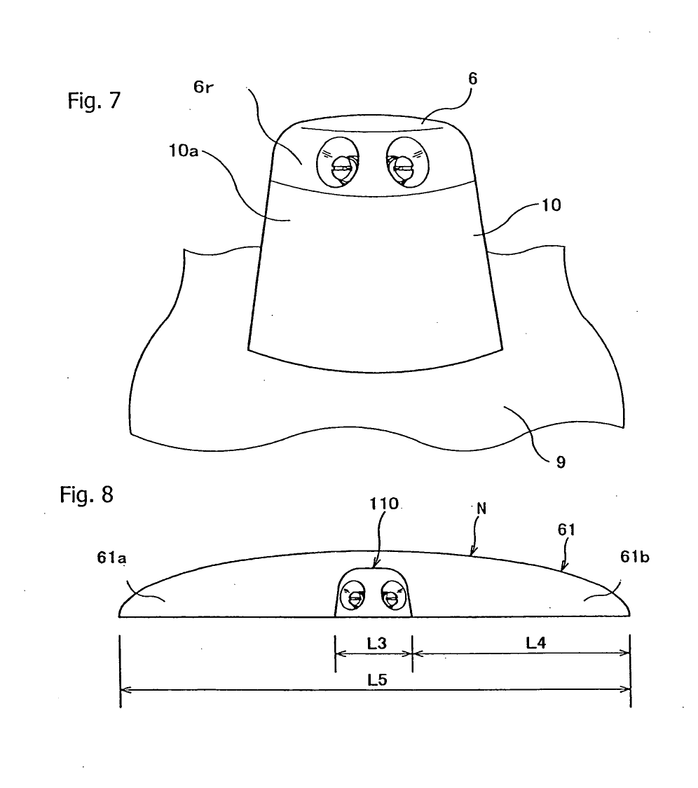

Next, referring to FIGS. 6 and 7, a vehicular washer nozzle according to a second embodiment of the present invention will be described below.

FIG. 6 is a drawing showing a vehicular washer nozzle according to a second embodiment of the present invention, which is an end view showing a state in which a nozzle main body is set in place. FIG. 7 is a drawing showing the vehicular washer nozzle according to the second embodiment of the present invention, which is an enlarged perspective view of the nozzle main body as seen from the interior of a passenger compartment. The second embodiment of the present invention relates to a placing means for placing the washer nozzle WN described in the first embodiment on the cowl top 9 of the vehicle 1, and like reference numerals are used for like constituent components to those described in the first embodiment, and the description thereof will be omitted herein.

As shown in FIGS. 6 and 7, the cowl top 9 is made up of a resin plate member provided in such a manner as to continue to an engine hood 11 side of the windscreen 2. A base seat 10 is placed on the cowl top 9 so that the washer nozzle WN is rested thereon.

The nozzle main body 6 is mounted on the base seat 10 which is rested on the cowl top 9. The base seat 10 is a base for resting the nozzle main body 6 at a position which is separated apart high above the surface of the cowl top 9 and is fixed to or formed integrally on the cowl top 9. A surface 10a of the base seat 10 is formed so as to continue to a surface 6r of the nozzle main body 6.

Thus, with the vehicular washer nozzle according to the second embodiment of the present invention, since the nozzle main body 6 is rested on the base seat 10, even in the event that the nozzle main body 6 is placed on the cowl top 9 at a position next to the windscreen 2, the washer fluid W can be injected over a wide range on the windscreen 2 to an upper position thereof.

In addition, the position of the nozzles (7, 8) can be made higher by resting the nozzle main body 6 on the base seat 10 and the orientation of the nozzles (7, 8) can easily be set. Accordingly, the base seat 10 becomes effective, in particular, when the nozzle main body 6 is placed on a vehicle having an engine hood 11 whose surface is made up of a steeply inclined surface or a vehicle such as a so-called one-box vehicle which has no engine hood.

Namely, in a case where the nozzle main body 6 is placed on the engine hood which has a steep gradient, the position of the nozzles (7, 8) is located at a position below the windscreen 2. Accordingly, when the vehicle runs at high speeds, the washer fluid W which is injected from the nozzles (7, 8) becomes easy to be affected by an air flow blown from the front of the vehicle. Since the position of the nozzles (7, 8) is raised by raising the position of the nozzle main body 6 by means of the base seat 10, the position of the nozzle main body 6 can be raised such that the washer fluid W can be injected from the front of the windscreen 2. Therefore, the washer fluid W which has been injected from the washer nozzle WN can be injected over the wide range on the windscreen 2 to an upper position thereon.

In addition, since the surface 10a of the base seat 10 is formed so as to continue to the surface 6r of the nozzle main body 6, the surface 10a of the base seat 10 and the surface 6r of the nozzle main body 6 become flush with each other. Thereby the air regulating function to regulate an air flow around a bottom circumference of the nozzle main body 6 is enhanced. Accordingly making it possible to reduce the effect of the air flow on the washer fluid W so injected.

Note that while, in the previous embodiment, the extended portions 6g, 6h are made to extend the length which is equal to or longer than the transverse length of the openings 6c, 6d (L1≧L2), the extended portions 6g, 6h may be made to extend a length which is equal to or longer than a half of the transverse length of the openings 6c, 6d and also is shorter than the transverse length of the openings 6c, 6d (L2/2≦L1<L2). In this case, the nozzle main body 6 can be formed into a shape which imposes no effect on the design of the washer nozzle and which can obtain the air regulating function to regulate an air flow.

[Embodiments]

[First Embodiment]

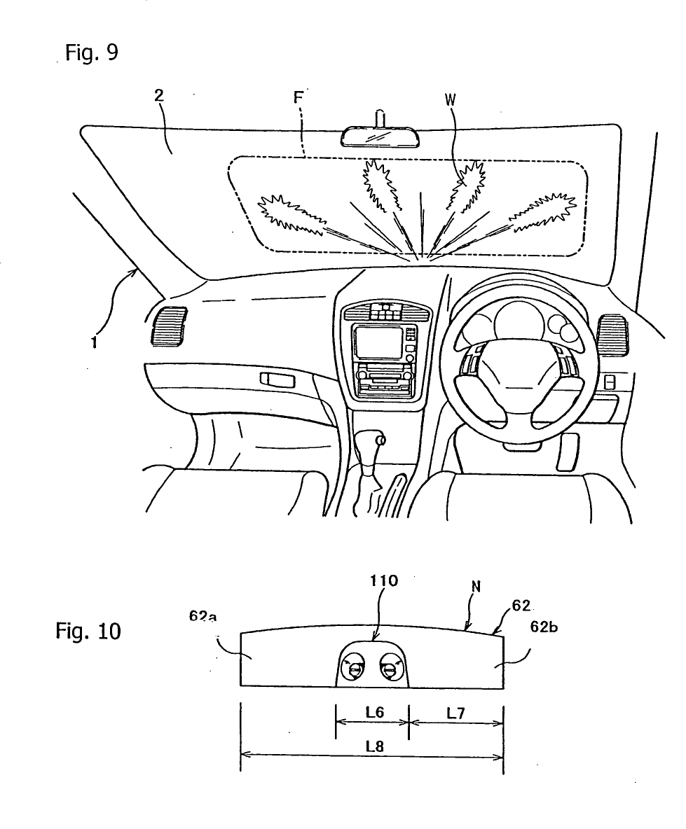

Next, referring to FIGS. 8 and 9, a vehicular washer nozzle according to a first example will be described below.

FIG. 8 is a drawing showing a vehicular washer nozzle according to the first embodiment of the present invention. FIG. 8 is a back view of a nozzle main body having extended portions which are formed on a conventional nozzle main body using clay. FIG. 9 is an explanatory drawing illustrating a state in which a washer fluid reaches the windscreen of a vehicle while the vehicle on which the nozzle main body shown in FIG. 8 is mounted is running at 100 km/h after the washer fluid has been injected from the nozzle main body so mounted.

The first embodiment of the present invention is such as to show a test example. The vehicle runs at 100 km/h in a state that the vehicle has the conventional nozzle main body 110 as shown in FIG. 14 and the extended portions formed from clay mounted on the conventional nozzle.

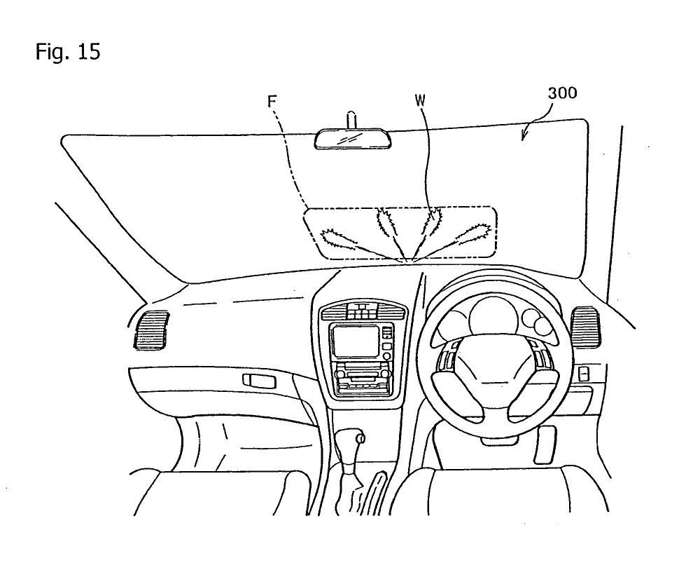

Like reference numerals are imparted to like constituent components to those described in the first and second embodiment and those described in the section (refer to FIGS. 14 and 15) of this specification which describes the problems that the present invention is to solve, and the description thereof will be omitted herein.

As shown in FIG. 8, in a clay added nozzle main body 61, extended portions 61a, 61b each having a transverse length L4 of 33 mm are formed from a clay N on both sides of a conventional nozzle main body 110 (refer to FIG. 14). The conventional nozzle main body of a conventional washer nozzle 100 (refer to FIG. 14) has a transverse width L3 of 19 mm so as to extend transversely. The overall transverse length L5 of the clay added nozzle main body 61 is made to become 85 mm.

Thus, in the vehicular washer nozzle according to the first embodiment of the present invention, the extended portions 61a, 61b are formed which each has the length L4 which is longer by two and a half times than the width L3 of the conventional nozzle main body 110. Due to this construction, as shown in FIG. 9, even when the vehicle is running at such a high speed of 100 km/h, the washer fluid which reaches the windscreen is least affected by the air flow produced by the running of the vehicle. Accordingly the washer fluid is allowed to reach the substantially same reaching position on the windscreen 2 as the reaching position resulting thereon when the vehicle 1 is stationary. The washer fluid can be injected over the wide range on the windscreen 2 to an upper position thereon and thus, a wide washer fluid reaching area F can be obtained.

[Second Embodiment]

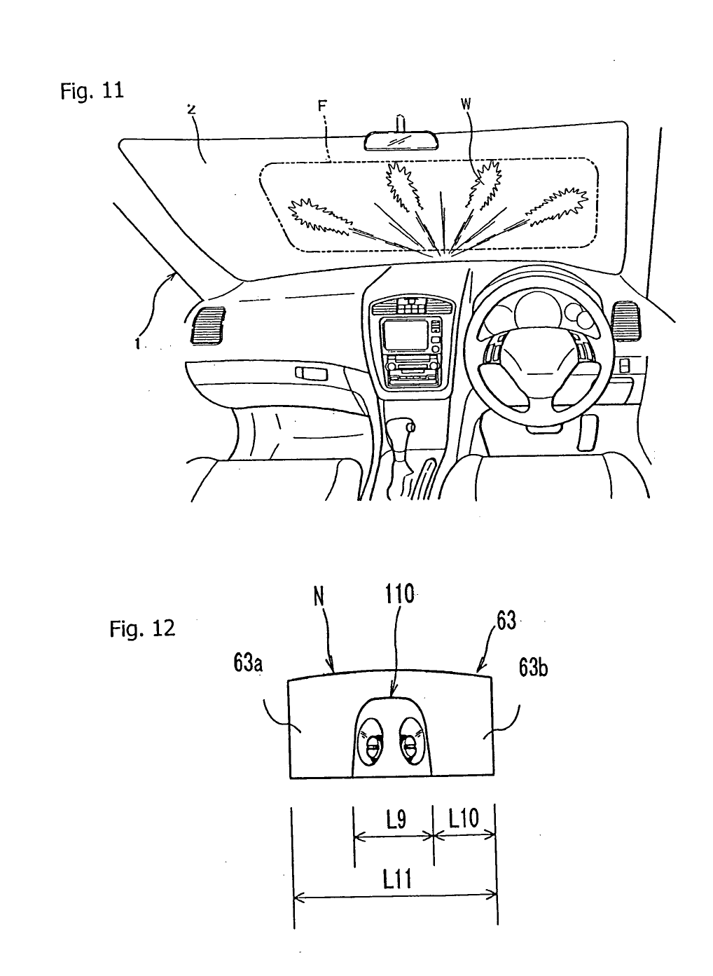

Next, referring to FIGS. 10 and 11, a vehicular washer nozzle according to a second embodiment will be described below.

FIG. 10 is a drawing showing a vehicular washer nozzle according to the second embodiment of the present invention, which is a back view of a nozzle main body having extended portions formed on a conventional nozzle main body using clay. FIG. 11 is an explanatory drawing illustrating a state in which a washer fluid reaches the windscreen of a vehicle while the vehicle on which the nozzle main body shown in FIG. 10 is mounted is running at 100 km/h after the washer fluid has been injected from the nozzle main body so mounted.

The second embodiment of the present invention is such as to show a test example in which the vehicle 1 was caused to run at 100 km/h while the vehicle has the conventional nozzle main body 110 shown in FIG. 14 and the extended portions formed on the conventional nozzle main body 110 from clay.

Like reference numerals are imparted to like constituent components to those described in the first and second embodiment and those described in the section (refer to FIGS. 14 and 15) of this specification which describes the problems that the present invention is to solve, and the description thereof will be omitted herein.

In a clay added nozzle main body 62, extended portions 62a, 62b each having a transverse length L7 of 15 mm are formed from a clay N on both sides of a conventional nozzle main body 110 (refer to FIG. 14). Also The transverse width L6 of the extended portions is 19 mm so as to extend transversely, then the overall transverse length L8 of the clay added nozzle main body 62 is made to become 50 mm.

Thus, in the vehicular washer nozzle according to the first embodiment of the present invention, the extended portions 62a, 62b are formed which each has the length L7 which is three quarters of the width L6 of the conventional nozzle main body 110. Due this construction, as shown in FIG. 11, even when the vehicle is running at such a high speed of 100 km/h, the washer fluid is least affected by the air flow produced by the running vehicle. As in the case with the first embodiment, even with the transverse length L7 of the extended portions 62a, 62b being made shorter to substantially a half of the transverse length L7 of the extended portions 62a, 62b. Accordingly, the washer fluid is allowed to reach the substantially same reaching position on the windscreen 2 as the reaching position resulting thereon when the vehicle 1 is stationary. The washer fluid can be injected over the wide range on the windscreen 2 to an upper position thereon and thus, a wide washer fluid reaching area F can be obtained.

[Third Embodiment]

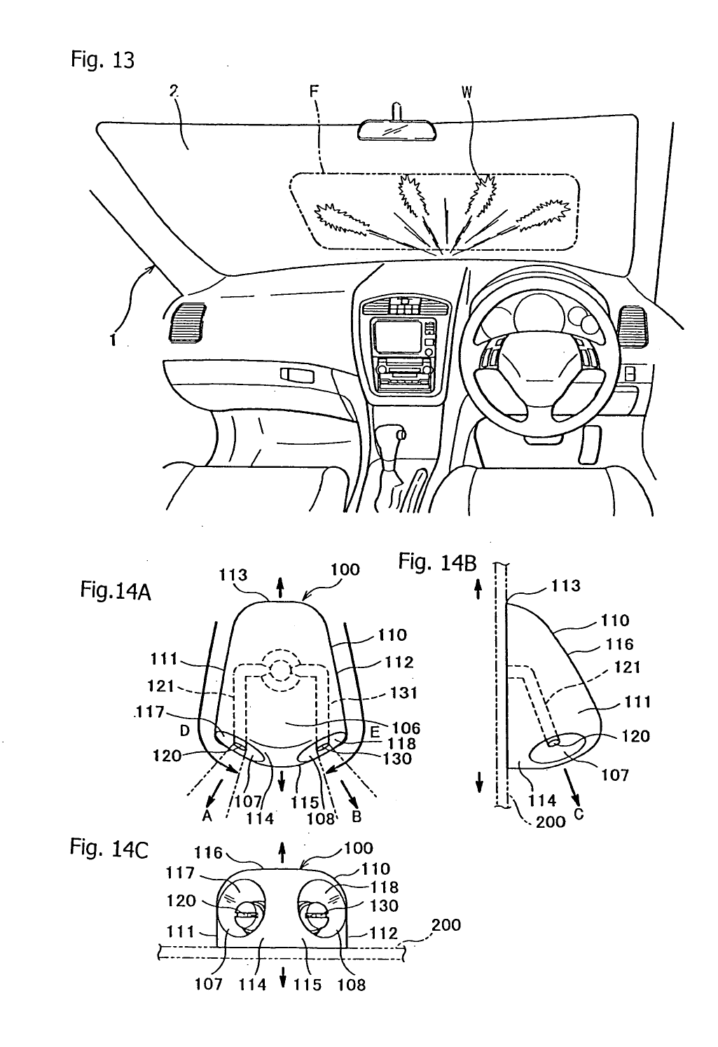

Next, referring to FIGS. 12 and 13, a vehicular washer nozzle according to a third embodiment will be described below.

FIG. 12 is a drawing showing a vehicular washer nozzle according to the third embodiment of the present invention. FIG. 12 is a back view of a nozzle main body having extended portions which are formed on a conventional nozzle main body using clay. FIG. 13 is an explanatory drawing illustrating a state in which a washer fluid reaches the windscreen while a vehicle on which the nozzle main body shown in FIG. 12 is mounted is running at 100 km/h after the washer fluid has been injected from the nozzle main body so mounted.

The third embodiment of the present invention is such as to show an test example in which the vehicle was caused to run at 100 km/h in a state that the vehicle has the conventional nozzle main body 110 as shown in FIG. 14 of a conventional washer nozzle 100 and the extended portions 63a, 63b made of a clay K mounted on the conventional nozzle main body 110.

Like reference numerals are imparted to like constituent components to those described in the first and second embodiment and those described in the section (refer to FIGS. 14 and 15) of this specification which describes the problems that the present invention is to solve, and the description thereof will be omitted herein.

In a clay added nozzle main body 63, the extended portions 63a, 63b each having a transverse length L10 of 9 mm are formed on both sides of a conventional nozzle main body 110 (refer to FIG. 14) and having a transverse width L9 of 19 mm in such a manner as to extend transversely, so that the overall transverse length L11 of the clay added nozzle main body 63 is made to become 37 mm.

Thus, in the vehicular washer nozzle according to the third embodiment of the present invention, the extended portions 63a, 63b are formed which each has the length L10 which is about a half of the width L9 of the conventional nozzle main body 110. From this construction, as shown in FIG. 13, when the vehicle is running at such a high speed of 100 km/h, the washer fluid W which reaches the windscreen is slightly affected by the air flow produced by the running vehicle. The washer fluid reaching position on the windscreen 2 is slightly lowered, in the event that the transverse length L10 of the extended portions 63a, 63b is reduced to a length which is substantially a half of the transverse length described in the second example. However, the washer fluid W is allowed to be injected over the wide range on the windscreen 2 to an upper position thereon and thus, a wide washer fluid reaching area F can be obtained.

Note that the vehicular washer nozzle according to the present invention is not limited to the embodiments and examples that have been described heretofore, and various modifications and changes can be made thereto without departing from the sprit and scope of the technical idea of the present invention, and it goes without saying that the present invention includes those modifications and changes.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

According to the vehicular washer nozzle according to the present invention, since the air flow caused while the vehicle is running is prevented from coming around the end portion of the nozzle main body to reach the opening therein by the extended portion. The extended portion is provided at the transverse end portion of the vehicle main body. The washer fluid that has just been injected is allowed to continue to be so injected without being affected by the air flow Thus, with the vehicular washer nozzle of the present invention, even when the vehicle is running at high speeds, the washer fluid that is injected can be injected to the windscreen so as to expand in the transverse direction, and hence, a desired injecting condition can be obtained, which results in an ideal washer fluid reaching area on the windscreen.

1. A vehicular washer nozzle for ejecting a washer fluid, comprising:
a nozzle main body provided with an opening through which washer fluid is ejected, the nozzle main body including;
an extended portion provided on an end portion located transversely outward of the opening; and
at least one nozzle for injecting the washer fluid
wherein the extended portion extends to a transversely outward direction for preventing an air flow from coming around the end portion and then flowing transversely inwardly.

2. The vehicular washer nozzle as set forth in claim 1, wherein a transverse length of the extended portion is equal to or longer than a transverse length of the opening.

3. The vehicular washer nozzle as set forth in claim 1, wherein a transverse length of the extended portion is equal to or longer than a half of a transverse length of the opening, and is shorter than a transverse length of the opening.

4. The vehicular washer nozzle as set forth in claim 1, wherein the end portion is formed so as to extend transversely outwardly as the end portion extends toward an opposite direction to a traveling direction of a vehicle.

5. The vehicular washer nozzle as set forth as in claim 1, further comprising:
a base seat,
wherein the nozzle main body is provided on the base seat, and
a surface of the base seat is formed continuously from a surface of the nozzle main body.

6. The vehicular washer nozzle as set forth in claim 1, wherein the nozzle main body is of a spray type.

7. The vehicular washer nozzle as set forth in claim 1, wherein the opening is provided so as to be inclined transversely outwardly at an angle of about 25° with respect to a rear direction of a vehicle as viewed from a top of the nozzle main body.

8. The vehicular washer nozzle as set forth in claim 7, wherein the nozzle is formed so as to be inclined in the same direction as that of the opening.

9. The vehicular washer nozzle as set forth in claim 1, wherein the opening is formed so as to be inclined upwardly at an angle of about 12° with respect to a rear direction of a vehicle as viewed from a side of the nozzle main body.

10. The vehicular washer nozzle as set forth in claim 9, wherein the nozzle is formed so as to incline in the same direction as that of the opening.

11. The vehicular washer nozzle as set forth in claim 1, wherein the vehicular washer nozzle has first and second nozzles,
the first nozzle has an ejecting direction directed along a center axis of a first ejecting direction that is inclined transversely outwardly at an angle of about 16° as viewed from a top of the nozzle main body, and
the second nozzle has an ejecting direction directed along a center axis of a second ejecting direction that is inclined transversely outwardly at an angle of about 23° as viewed from a top of the nozzle main body.

12. The vehicular washer nozzle as set forth in claim 1, wherein the nozzle is disposed in such a manner that a center axis of an ejecting direction is inclined upwardly at an angle of about 20° as viewed from a side of the nozzle main body.

13. The vehicular washer nozzle as set forth in claim 1, wherein an angle defined between side surfaces of the nozzle main body is about 33°.

14. The vehicular washer nozzle as set forth in claim 1, wherein a front surface of the nozzle main body is formed substantially into a flat shape as viewed from a top of the nozzle main body

15. The vehicular washer nozzle as set forth in claim 1, wherein a rear surface of the nozzle main body is formed substantially into an arc-like shape as viewed from a top of the nozzle main body.

16. The vehicular washer nozzle as set forth in claim 1, wherein a top surface of the nozzle main body is formed substantially into a triangular shape and descend toward a front direction as viewed from a side of the nozzle main body.

17. The vehicular washer nozzle as set forth in claim 1, wherein
an edge defined between a side surface and a rear surface comprises a round shape.

18. The vehicular washer nozzle as set forth in claim 5, wherein
the base seat is formed integrally with the nozzle main body.

19. The vehicular washer nozzle as set forth in claim 1, wherein
the nozzle main body and the extended portion are formed separately.

20. A vehicular washer nozzle for ejecting a washer fluid, comprising:
a nozzle main body provided with an opening through which washer fluid is ejected, the nozzle main body including;
an end portion located on a transversely outward end of the opening;
an extended portion extended from the end portion of the nozzle main body to a transversely outward direction; and
at least one nozzle for ejecting the washer fluid,
wherein the extended portion prevents an air flow from coming around the end portion and then flowing transversely inwardly.
